(19) United States
(12) Patent Application Publication
(10) Pub. No.: US 2014/0267325 A1
(43) Pub. Date: Sep. 18, 2014

(54) METHOD FOR DETECTING DISPLAY PROPERTIES

(71) Applicant: Motorola Mobility LLC, Libertyville, IL (US)

(72) Inventors: Jun Jiang, Lake Zurich, IL (US); XiaoPing Bai, Lake Zurich, IL (US)

(73) Assignee: Motorola Mobility LLC, Libertyville, IL (US)

(21) Appl. No.: 14/143,523

(22) Filed: Dec. 30, 2013

Related U.S. Application Data
(60) Provisional application No. 61/784,120, filed on Mar. 14, 2013.

(51) Int. Cl. G09G 5/00

(52) U.S. Cl. CPC G09G 5/006
USPC 345/520

(57) ABSTRACT

A method and system evaluates user interfaces (UIs) for presentation on a display of a mobile communication device. A display controller, in response to detecting an initiation of a presentation of a specified UI on the display, determines a type of the display by evaluating power consumption behavior of the display associated with individually presenting each of multiple pre-defined UIs on the display. Based on the display type, the display controller identifies a specific display parameter associated with the display and which identifies relevant image characteristics of UIs that can be presented on the display. The display controller evaluates a display parameter value for the specified UI, compares the display parameter value with a threshold display parameter value, and provides a notification that indicates, based on a result of the comparison, whether the specified UI satisfies the power consumption specification and is recommended for presentation on the display.

### BACKGROUND

1. Technical Field

The present disclosure relates in general to mobile communication devices and in particular to managing display power usage in mobile communication devices.

2. Description of the Related Art

Reducing a rate of battery power drain is one an important consideration in the design and usage of today's mobile electronic devices and/or mobile communication devices. Considering all components within the mobile device, the display contributes significantly to power consumption. Currently, the most popular displays for mobile devices are liquid crystal displays (LCDs) and organic light-emitting diode (OLED) displays. LCDs and OLED displays have different electro-optical properties. For example, for a specific type of image content that has dominant bright pixel distribution, an LCD typically provides greater power efficiency than the efficiency provided by an OLED display. However, for other image content that has dominant dim pixel distribution, an OLED display provides greater power efficiency. End users of mobile communication devices, while personalizing UIs on their devices, are typically unaware of the differences in displays and properties associated with each display. As a result, users may unknowingly select a picture created in a first format or run a particular version of a software application that does not work to the advantage of the display and consequently negatively impact the rate of decreasing charge of the battery and/or the battery life.

### BRIEF DESCRIPTION OF THE DRAWINGS

The described embodiments are to be read in conjunction with the accompanying drawings, wherein:

FIG. 1 is a block diagram illustrating an example mobile communication device within which the various features of the described embodiments can be advantageously implemented, according to one embodiment;

FIG. 2 provides a graph of power consumption distribution waveforms illustrating power consumed by each of a pair of displays when presenting pre-defined user interfaces (UIs) having distinguishable image characteristics, according to one embodiment;

FIG. 3 is a table mapping a particular display type to power consumption distributions associated with presenting UIs on a display, according to one embodiment;

FIG. 4 is a table identifying power consumption specifications for a particular display type and corresponding image characteristic parameter values, according to one embodiment;

FIG. 5 is a flow chart illustrating one embodiment of a method for determining, within a mobile communication device, a display type of a display based on a real-time power consumption behavior of the display;

FIG. 6 is a flow chart illustrating one embodiment of a method for evaluating a UI to determine whether a display can satisfy a specified power consumption if the UI is presented on the display;

FIG. 7 is a flow chart illustrating one embodiment of a method for evaluating a UI to determine whether a display can satisfy a specified power consumption for low battery power if the UI is presented on the display during a low battery power state of the mobile communication device; and

FIG. 8 provides a power consumption distribution waveform illustrating power consumed by an organic light-emitting diode (OLED) display when presenting pre-defined user interfaces (UIs) having distinguishable image characteristics, according to one embodiment.

### DETAILED DESCRIPTION

The illustrative embodiments provide a method and system for evaluating user interfaces (UIs) for presentation on a display of a mobile communication device. A display controller, in response to detecting initiation of a presentation of a specified UI on the display, determines a type of the display by evaluating power consumption behavior of the display based on power consumed in order to individually present each of multiple pre-defined UIs on the display. Each of the pre-defined UIs has distinguishable image characteristics which, when coupled with the unique characteristics of different displays, enable the pre-defined UIs to cause various displays of different display types to exhibit and be associated with distinguishable power consumption behaviors. Based on the determined display type, the display controller identifies a specific display parameter associated with the display and which identifies relevant image characteristics of UIs that can be presented on the display. The identified display parameter has an associated display parameter value for a specific UI. The display controller evaluates the display parameter value for a specified UI and compares the display parameter value with a threshold display parameter value to determine if the specified UI satisfies the power consumption specification for presentation of a UI on the display. In addition, the display controller provides a notification that indicates, based on a result of the comparison, whether the specified UI satisfies the power consumption specification and is recommended for presentation on the display.

In the following detailed description of exemplary embodiments of the disclosure, specific exemplary embodiments in which the various aspects of the disclosure may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present disclosure. The following detailed description is, therefore, not to be taken in a limiting sense, and the scope of the present disclosure is defined by the appended claims and equivalents thereof.

Within the descriptions of the different views of the figures, similar elements are provided similar names and reference numerals as those of the previous figure(s). The specific numerals assigned to the elements are provided solely to aid in the description and are not meant to imply any limitations (structural or functional or otherwise) on the described embodiment.

It is understood that the use of specific component, device and/or parameter names, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that terms is utilized.

As further described below, implementation of the functional features of the disclosure described herein is provided within processing devices and/or structures and can involve use of a combination of hardware, firmware, as well as several software-level constructs (e.g., program code and/or program instructions and/or pseudo-code) that execute to provide a specific utility for the device or a specific functional logic. The presented figures illustrate both hardware components and software and/or logic components.

Those of ordinary skill in the art will appreciate that the hardware components and basic configurations depicted in the figures may vary. The illustrative components are not intended to be exhaustive, but rather are representative to highlight essential components that are utilized to implement aspects of the described embodiments. For example, other devices/components may be used in addition to or in place of the hardware and/or firmware depicted. The depicted example is not meant to imply architectural or other limitations with respect to the presently described embodiments and/or the general invention.

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein.

With specific reference now to FIG. 1, there is depicted a block diagram of an example mobile communication device 100, within which the functional aspects of the described embodiments may be implemented. Mobile communication device 100 represents a device that is adapted to transmit and receive electromagnetic signals over an air interface via uplink and/or downlink channels between the mobile communication device 100 and communication network equipment (e.g., base-station 145) utilizing a plurality of different communication standards, such as Global System for Mobile Communications (GSM) Code Division Multiple Access (CDMA), Orthogonal Frequency Division Multiple Access (OFDMA), and similar systems. In one or more embodiments, the mobile communication device can be a mobile cellular device/phone or smartphone, or laptop, netbook or tablet computing device, or other types of communications devices. Mobile communication device 100 comprises processor 105 and interface circuitry 125, which are connected to memory component 106 via signal bus 102. Interface circuitry 125 includes digital signal processor (DSP) 128. Mobile communication device 100 also comprises display 116 and display controller 120 which includes display drivers 121. Display controller 120 is coupled to display 116 and includes functions to enable display controller 120 to operate as a user interface controller. These functions include evaluating a UI to determine whether display 116 can satisfy power consumption specifications when the UI is presented on display 116. Display 116 includes display drive circuit 118. Display controller 120 is able to monitor display drive circuit 118 to determine a real-time current drain and voltage of display drive circuit 118 in order to compute a power consumption of display 116.

In addition, mobile communication device 100 comprises storage 122. Also illustrated within mobile communication device 100 are other input/output (I/O) devices 124. Mobile communication device 100 also includes a transceiver module 130 for sending and receiving communication signals. In at least some embodiments, the sending and receiving of communication signals occur wirelessly and are facilitated by one or more antennas 140 coupled to transceiver module 130. The number of antennas can vary from device to device, ranging from one antenna to a plurality of antennas, and the presentation within mobile communication device 100 of one antenna 140 is merely for illustration.

Mobile communication device 100 is able to wirelessly communicate to base-station 145 via antenna 140. Base station 145 can be any one of a number of different types of network equipment and/or antennas associated with the infrastructure of the wireless network and configured to support uplink and downlink communication via one or more of the wireless communication protocols, as known by those skilled in the art.

In addition to the above described hardware components of mobile communication device 100, various features of the invention may be completed or supported via software or firmware code and/or logic stored within at least one of memory 106 and local storage 122, and respectively executed by DSP 128 or processor 105. According to one aspect of the disclosure, the software or firmware code and/or logic supports the various processing functions of display controller 120. Thus, for example, included within system memory 106 and/or storage 122 are a number of software, firmware, logic components, or modules, including applications 114, display parameter and power consumption specifications 110 and UI controller (UIC) utility 115. Memory 106 also includes power consumption distribution data 112 and pre-defined UI data 108.

The various components within mobile communication device 100 can be electrically and/or communicatively coupled together as illustrated in FIG. 1. As utilized herein, the term “communicatively coupled” means that information signals are transmissible through various interconnections between the components. The interconnections between the components can be direct interconnections that include conductive transmission media, or may be indirect interconnections that include one or more intermediate electrical components. Although certain direct interconnections are illustrated in FIG. 1, it is to be understood that more, fewer or different interconnections may be present in other embodiments.

According to one or more aspects of the disclosure, mobile communication device 100 and, in particular, display controller 120, detects when a specified or target UI is selected for presentation on display 116 by initiation of one or more processes. In response to detecting the initiation of the change of UI presentation on display 116, display controller 120 determines a type of the display to be used for presentation of the UI by evaluating a power consumption behavior of display 116. Display controller 120 evaluates the power consumption behavior by monitoring power consumed by display 116 while display 116 individually presents each one of a plurality of pre-defined UIs each having distinguishable image characteristics. The distinguishable image characteristics respectively associated with the plurality of pre-defined UIs cause different displays having different display types to exhibit and be associated with distinguishable power consumption behaviors. Based on the determined display type, display controller 120 identifies a specific display parameter and a first threshold display parameter value associated with power consumption specifications 110 for display 116. The specific display parameter identifies relevant image characteristics of UIs that can be presented on display 116. It is appreciated that this determination is actually performed only once during or following startup of mobile communication device 100, and the resulting display type determined is stored in system memory 122 or storage 122 for access during subsequent presentation of new target UIs.

Display controller 120 evaluates a display parameter value for the specified UI based on the image characteristics of the specified UI. Display controller 120 compares the display parameter value of the specified UI with the first threshold display parameter value to determine if the specified UI satisfies a power consumption specification for presentation of a UI on display 116. In addition, display controller 120 provides a notification that indicates, based on a result of the comparison, whether the specified UI satisfies the power consumption specification and is recommended for presentation on the display. More particularly, display controller 120 compares the display parameter value of the specified UI with the first threshold display parameter value corresponding to a recommended power consumption identified using power consumption specifications 110 of display 116. In response to the display parameter value being at least equal to the first threshold display parameter value, display controller 120 provides an approval for presentation of the specified UI on display 116. Alternatively, in response to the display parameter value being less than the first threshold display parameter value, display controller 120 provides a notification that the specified UI is not recommended for presentation on display 116.

FIG. 2 provides a graph of power consumption distribution waveforms illustrating power consumed by each of a pair of displays when presenting pre-defined user interfaces (UIs) having distinguishable image characteristics, according to one embodiment. Distribution graph 200 comprises first waveform 204 that corresponds to a liquid crystal display (LCD) and second waveform 208 that corresponds to an organic light-emitting diode (OLED) display. Distribution graph 200 also comprises a pair of rectangular axes including first axis 202 that identifies power consumption and a second axis that identifies UI image characteristics. In the example provided by distribution graph 200, first axis 202 identifies for a respective display power consumed using numerical values identifying power consumed in units of power. However, second axis 206 identifies image characteristics for different UIs by individually providing along second axis 206 visual images of the pre-defined UIs. Alternatively, each pre-defined UI can be identified by a corresponding numerical value for an image characteristic such as image brightness or image dimness.

The pre-defined UIs represent a diverse collection of UIs, which include, for example, first UI_212, second UI_214, third UI_216 and fourth UI_218, among others. An LCD has different electro-optical properties compared to an OLED display. More simply, the LCD and the OLED display have different power consumption characteristics depending on image content. A parameter of image characteristics that measures image characteristics to which a display is most responsive and/or highly responsive (i.e., based on the display's electro-optical properties) is pixel illumination. Pixel illumination can be measured using pixel brightness or pixel dimness. Based on pixel illumination, first UI_212, which is a “full” black image, represents a pre-identified high level of pixel dimness (i.e., a low level of pixel brightness) and fourth UI_218, a full white image, represents a pre-identified high level of pixel brightness (i.e., a low level of pixel dimness).

First waveform 204 indicates that the LCD has very small variation in power consumption over various types of image content. Second waveform 208 indicates that the OLED display has substantially larger variations in power consumption over various types of image content and that power consumption of the OLED display is highly correlated to image content. Second waveform 208 also indicates that the low and high power consumption limits are associated with the full black image and the full white image respectively. Thus, a power consumption behavior and distribution corresponding to an LCD can be distinguished from a power consumption behavior/distribution of the OLED display. As a result, the display type can be identified based on the level of variation of power consumed when the display presents at least two different UIs (e.g., at least one full black image and one full white image).

Furthermore, based on consumption behaviors, it can be concluded that greater power efficiency is achieved if brighter images are presented on the LCD and dimmer images are presented on the OLED display. In one embodiment, based on this conclusion, a pixel brightness parameter is pre-selected for quantifying image characteristics for UIs being displayed on the LCD, and a pixel dimness parameter is pre-selected for quantifying image characteristics for UIs being displayed on the OLED display. In general, for certain type of image content that has dominant bright pixel distribution, an LCD is more power efficient than an OLED display. However for some other image content that has dominant dim pixel distribution, an OLED display is more power efficient.

In one embodiment, based on analysis of power consumption characteristics, a number of thresholds (e.g., threshold 215) identifiable by specific image characteristics can be established for determining whether an observed consumption behavior is provided by an LCD or an OLED display. For example, threshold 215 is a specific power consumption value and may be used to evaluate a display type when a full black or full white UI image is presented on the display. Alternatively, a parameter for determining display type can be based on a waveform extinction ratio. The waveform extinction ratio is determined from a ratio of maximum power consumption and minimum power consumption associated with displaying a selected UI or a selected group of UIs. Furthermore, a ratio (e.g., the waveform extinction ratio) can be calculated from a first average power consumption associated with displaying UI_{—}1 and a second average power consumption associated with displaying UI_{—}2. If the waveform extinction ratio is calculated using a ratio of first and second average power consumption values, an impact of noise on determining a display's consumption behavior is minimized. The average power consumption values are calculated based on having multiple instances of UIs (e.g., multiple instances of UI_{—}1, multiple instances of UI_{—}2) presented on the display. Furthermore, by analysis of the observed consumption behavior and overall device power usage and availability, thresholds can be established to determine whether an expected power consumption associated with presenting a particular UI on a display falls within a preferred consumption range. More particularly, image characteristics corresponding to a maximum power specification for the display are identified. Similarly, image characteristics corresponding to a range of preferred consumption levels can also be established. In addition, image characteristics that can be supported when battery power reaches a low power level can also be identified.

In one embodiment, in order to evaluate power consumption behavior, display controller 120 determines real-time power consumption resulting from a presentation of the pre-defined UIs within display 116 and calculates a ratio of a first real-time power consumption associated with at least one UI from a first set of UIs and a second real-time power consumption associated with at least one UI from a second set of UIs. The first and second sets represent distinguishable sets based on a specific image characteristic parameter. In one embodiment, UIs within a single set are highly correlated with each other. Display controller 120 determines the display type of the display using the calculated ratio. In particular, display controller 120 compares the calculated ratio of the first real-time power consumption and the second real-time power consumption with a threshold consumption ratio. The threshold consumption ratio is a relative value for power consumption associated with displaying each of two different UIs or images on a same display. This relative value differs based on the different types of displays upon which the UIs are displayed. The threshold consumption ratio is a value that is selected to enable a first type of display to be clearly distinguishable from a second type of display. For example, a first type of display may be identified by a first power consumption ratio that is substantially larger than the threshold consumption value, while a second type of display may be identified by a second power consumption ratio that is substantially lower than the threshold consumption value. More generally, at least one of the first and second power consumption ratios must substantially differ from the threshold consumption value to enable each of the respective displays to be clearly distinguishable from each other. Referring again to the calculated ratio, in response to the calculated ratio being at least equal to the threshold consumption ratio, display controller 120 identifies the display type of the display as a first display type. In response to the calculated ratio being less than the threshold consumption ratio, display controller 120 identifies the display type of the display as a second display type.

In one embodiment, display controller 120 determines real-time power consumption to identify the display type of the display in response to detecting device initialization. In another embodiment, display controller 120 determines display type by using other electro-optical characteristics of the display. For example, display controller 120 can determine display type based on (probing) a unique drive voltage of internal drive circuit 118 of display 116. Following an initial identification of the display type using real-time power consumption, display controller 120 stores the determined display type of display 116. In response to a subsequent and specific change in battery power and/or an initiation of a change of target UI for presentation on display 116, display controller 120 retrieves from storage the determined display type to identify the display parameter and power consumption specifications of the display.

In one implementation, the evaluation of image characteristics of a specified or a target UI includes determining for the specified UI a distribution of pixels comprising at least one of bright pixels and dim pixels. If display controller 120 identifies the display as a first type (e.g., an LCD), display controller 120 identifies, using display and power consumption specifications 110, a bright pixel parameter as the relevant display parameter and calculates a bright pixel count or factor using the determined distribution of pixels. A display parameter identifies specific image characteristics for the specified UI. In addition, display controller 120 determines a value for a bright pixel ratio from a ratio of the bright pixel count and a total pixel count. In one embodiment, display controller 120 specifically identifies a bright pixel ratio parameter as the relevant display or specific image characteristic parameter for the specified UI. Display controller 120 compares the value for the bright pixel ratio to a threshold bright pixel ratio. In response to the value for the bright pixel ratio being greater than the value of the threshold bright pixel ratio, display controller 120 indicates that the specified UI is recommended for presentation within the display. However, in response to the value for the bright pixel ratio not being greater than the value of the threshold bright pixel ratio, display controller 120 indicates that the specified UI is not recommended for presentation within display 116.

If display controller 120 identifies the display as a second type (e.g., an OLED display), display controller 120 identifies, using display and power consumption specifications 110, a dim pixel parameter as the relevant display parameter and calculates a dim pixel count using the determined distribution of pixels. In addition, display controller 120 determines a value for a dim pixel ratio from a ratio of the dim pixel count and the total pixel count. In one embodiment, display controller 120 specifically identifies a dim pixel ratio parameter as the relevant display or specific image characteristic parameter for the specified UI. Display controller 120 compares the value for the dim pixel ratio to a threshold dim pixel ratio value. In response to the value for the dim pixel ratio being greater than a threshold dim pixel ratio value, display controller 120 indicates that the specified UI is recommended for presentation within the display. In response to the value for the dim pixel ratio not being greater than the value of the threshold dim pixel ratio, display controller 120 indicates that the specified UI is not recommended for presentation within the display.

Display controller 120 is able to identify display type and selectively present UIs on the display in order to conserve battery power. The unique features and capabilities provided by display controller 120 can be appropriately applied to various types of applications. For example, the unique features and capabilities can be utilized within or integrated into a color management controller as a decision making component to enable enhanced selectively in determining suitable color management settings for camera and imaging applications.

FIG. 8 provides a power consumption distribution waveform illustrating power consumed by an organic light-emitting diode (OLED) display when presenting pre-defined user interfaces (UIs) having distinguishable image characteristics, according to one embodiment. Distribution graph 800 comprises power consumption waveform 804 which corresponds to an OLED display. Distribution graph 800 also comprises a pair of rectangular axes including first axis 802 that identifies power consumption and second axis 806 that identifies the time period during which display controller 120 repeatedly alternate between the presentation of a white and a black image.

In the example provided by distribution graph 800, the predefined UIs include first UIs 812, which are full white images or multiple instances of a same full white image presented on the OLED at various different time intervals including first time interval 808. In addition, the predefined UIs include second UIs 816, which are full black images or multiple instances of a same full black image presented on the OLED at various different time intervals including second time interval 810. The UIs are shown as a sequence of images at corresponding time intervals. As indicated, power consumption waveform 804 achieves maximum/high power consumption values during first time interval 808 when display controller 120 displays a white image on the OLED. However, power consumption waveform 804 achieves minimum/low power consumption values during second time interval 810 when display controller 120 displays a black image on the OLED.

The power consumption behavior illustrated in distribution graph 800 corresponds to real time battery activity corresponding to the presentation of full white images (i.e., first UIs 812) and full black images (i.e., second UIs 816) on the OLED display. More specifically, first (white) UIs 812 and second (black) UIs 816 are respectively presented on the OLED display by alternating/switching between displaying a full white image and a full black image, until each type of image is presented an identifiable number of instances on the OLED display.

Based on the power consumption behavior, a wave extinction ratio for the OLED is evaluated using an average of first power consumption values associated with displaying first (white) UIs 812 and an average of second power consumption values associated with displaying second (black) UIs 816. In a similar manner, a wave extinction ratio can be calculated for an LCD. In an empirical test environment, calculation of other parameters, such as a standard deviation or a variance of a respective wave extinction ratio can be used along with respective average wave extinction ratios to determine a threshold wave extinction ratio that maximizes detection probability. The detection probability represents a measure of the chance of correctly identifying a display type. For example, when a threshold wave extinction ratio is being applied instead of applying the threshold power consumption value (described in FIG. 2) to enable display controller 120 to distinguish between different types of display, the detection probability is enhanced especially in the presence of noise.

By monitoring the battery activity under controlled display events, display controller 120 is able to determine a display type based on detected display properties identified using power consumption behavior. In addition, in order to achieve maximum battery power saving, display controller 120 enables a selection of preferred UIs for presentation on a display based on the detected display properties.

FIG. 3 is a table mapping a particular display type to power consumption distributions associated with presenting UIs on a display, according to one embodiment. Table 300 provides power consumption behavior of a display relative to a collection of pre-defined UIs. The power consumption behavior for each of the various displays can be identified using information obtained from empirical testing. In table 300, a power consumption behavior of a display is identified using a power consumption distribution corresponding to the display. The first column of table 300 identifies a display type. The second column identifies a specific image characteristic corresponding to the display type. An image characteristic parameter is also referred to herein as a display parameter. The third column identifies the pre-defined UIs and provides the image characteristic parameter values for each of the pre-defined UIs, based on the specified image characteristic parameter. The fourth column provides power consumption distributions associated with presenting the pre-defined UIs on a particular display.

First row 302 indicates that an LCD is associated with parameter1 in the example of table 300. In addition, first row 302 identifies the pre-defined UIs as a collection that includes UI_{—}1 and UI_{—}2. UI_{—}1 has a parameter1 value of “X”, and UI_{—}2 has a parameter1 value of “Y”. First row 302 identifies the power consumption distribution associated with the LCD as a set comprising individual power consumption levels associated with an individual presentation of each one of the pre-defined UIs on the LCD. First row 302 specifically identifies the power consumption distribution as a vector of values comprising value1 which corresponds to UI_{—}1 and which has a value of level 1 and value2 which corresponds to UI_{—}2 and which has a same value of level 1, as shown in the fourth column. If, in an example implementation, UI_{—}1 represents a full black image and UI_{—}2 represents a full white image, a high similarity and/or an equality of value1 and value2 (as shown in the fourth column of first row 302) can indicate that a corresponding display can be identified as an LCD.

Second row 304 indicates that an OLED display is associated with parameter 2. In addition, second row 304 identifies the pre-defined UIs as a collection that includes UI_{—}1 and UI_{—}2. UI_{—}1 has a parameter2 value of “1−X”, and UI_{—}2 has a parameter2 value of “1−Y”.

Second row 304 identifies the power consumption distribution associated with the OLED display as a set comprising individual power consumption levels associated with an individual presentation of each one of the pre-defined UIs on the OLED display. Second row 304 specifically identifies the power consumption distribution as a vector of values comprising value1 which corresponds to UI_{—}1 and which has a value of level 2 and value2 which corresponds to UI_{—}2 and which has a value of level 5. If, in an example implementation, UI_{—}1 represents a full black image and UI_{—}2 represents a full white image, a difference between value1 and value2 being equal to a specified value can be used to indicate that a corresponding display can be identified as an OLED display.

FIG. 4 is a table identifying power consumption specifications for a particular display type and corresponding image characteristic parameter values, according to one embodiment. Table 400 comprises image characteristic parameter values that are generated using calculations and/or empirical data associated with presenting pre-defined UIs on a display. These calculations and/or empirical evaluations are provided based on a mathematical relationship between power consumption values and image characteristic parameter values. The first column of table 400 identifies a display type. The second column identifies a specific image characteristic corresponding to the display type. The third column provides power consumption specifications corresponding to a display having the identified display type. In particular, the third column provides the following power consumption specifications: (i) a maximum power consumption value; (ii) an acceptable and recommended power consumption range; and (iii) a low battery power consumption range corresponding to a low battery power state. The fourth column provides image characteristic parameter values corresponding to the power consumption specifications provided in the third column.

First row 402 indicates that an LCD is associated with parameter1 which is specifically identified as a bright pixel parameter in the example of table 400. In addition, first row 402 provides the following power consumption specifications for the LCD: (i) maximum power consumption is equal to “A”; (ii) the recommended power consumption range includes values that are larger than “C” and less than “A”; and (iii) the low battery power consumption range includes values that are less than “G”. The bright pixel parameter values corresponding to the power consumption specifications for the LCD display are indicated as follows: (i) maximum bright pixel parameter value is equal to “s”, corresponding to the maximum power consumption (i.e., A); (ii) the recommended bright pixel range includes values that are larger than “q” and less than “s”, corresponding to the recommended power consumption; and (iii) the low battery bright pixel range includes values that are less than “y”, corresponding to the low battery power consumption.

Second row 404 indicates that an OLED display is associated with parameter 2 which is specifically identified as a dim pixel parameter in the example of table 400. In addition, second row 404 provides the following power consumption specifications for the OLED display: (i) maximum power consumption is equal to “B”; (ii) the recommended power consumption range includes values that are larger than “D” and less than “B”; and (iii) the low battery power consumption range includes values that are less than “H”. The dim pixel parameter values corresponding to the power consumption specifications for the OLED display are indicated as follows: (i) maximum dim pixel parameter value is equal to “t”, corresponding to the maximum power consumption (i.e., B); (ii) the recommended dim pixel range includes values that are larger than “v” and less than “t”, corresponding to the recommended power consumption; and (iii) the low battery dim pixel range includes values that are less than “z”, corresponding to the low battery power consumption.

In one embodiment, display controller 120 accesses, using the display type, (i) display parameter specifications which are specific image characteristic parameter values and (ii) power consumption specifications of the display which provide at least one of: (a) a maximum power consumption that the display can support when a UI is presented within the display; (b) a recommended power consumption for the display when a UI is presented within the display; and (c) an acceptable, low power consumption corresponding to a low battery status. The display parameter specifications are respectively associated with and mapped to the power consumption specifications. In another embodiment, display controller 120 does not access or utilize actual power consumption values of the power consumption specifications. In this alternate embodiment, display controller 120 retrieves the display parameter specifications (which are associated with power consumption specifications for display 116) and evaluates a specified UI for presentation on display 116 by using at least one specified display parameter value and without explicitly utilizing an actual value provided by a particular power consumption specification.

FIGS. 5-7 are flow charts illustrating embodiments of various methods by which the above processes of the illustrative embodiments can be implemented. Although the method illustrated by FIGS. 5-7 may be described with reference to components and functionality illustrated by and described in reference to FIGS. 1-4, it should be understood that this is merely for convenience and alternative components and/or configurations thereof can be employed when implementing the method. Certain portions of the methods may be completed by UIC utility 115 executing on one or more processors (processor 105) within mobile communication device 100 (FIG. 1) or a processing unit or display controller 120 (FIG. 1). The executed processes then control specific operations of or on display 116. For simplicity in describing the method, all method processes are described from the perspective of display controller 120.

FIG. 5 illustrates one embodiment of a method for determining a display type of a target display based on a real-time power consumption behavior of the target display. The method of FIG. 5 begins at initiator block 501 and proceeds to block 502 at which display controller 120 initiates process to determine a power consumption behavior of the target display. Display controller 120 determines real-time power consumption of pre-defined UIs presented on the display (block 504). Display controller 120 calculates a ratio of a first real-time power consumption associated with a first UI and a second real-time power consumption associated with a second UI (block 506).

Display controller 120 determines whether the calculated ratio is less than the threshold consumption ratio (decision block 508). If the calculated ratio is not less than the threshold consumption ratio, display controller 120 identifies the display type of the display as a first display type (block 510). If the calculated ratio is less than the threshold consumption ratio, display controller 120 identifies the display type of the display as a second display type (block 512). In one embodiment, the first UI is a full black image, and the second UI is a full white image. As a result, the corresponding threshold consumption ratio (which can be expressed in decibel (dB) units) is selected as a first value (e.g., a relatively small value1 to enable a first type of display (e.g., an LCD display) and a second type of display (e.g., an OLED display) to be distinguishable using the calculated ratio. As a result, if the calculated ratio is not less than the threshold ratio, display controller 120 identifies the display as an LCD display. However, if the calculated ratio is less than the threshold ratio, display controller 120 identifies the display as an OLED display. In another embodiment, the first UI is a full white image, and the second UI is a full black image. As a result, the corresponding threshold consumption ratio is selected as a second value (e.g., a relatively large value1 to enable a first type of display (e.g., an LCD display) and a second type of display (e.g., an OLED display) to be distinguishable using the calculated ratio. As a result, if the calculated ratio is not less than the threshold ratio, display controller 120 identifies the display as an OLED display. However, if the calculated ratio is less than the threshold ratio, display controller 120 identifies the display as an LCD display. The process ends at block 514.

Identification of a target display using real-time power consumption measurements enables display controller 120 to correctly determine the type of installed display hardware. Occasionally, stored display ID information, identifying display type, incorrectly identifies the display type. This inability to correctly identify the display type occurs because default display hardware can be removed and replaced with custom display hardware (from a preferred vendor) based on a user's preference. Consequently, device operation and a user's viewing experience can be compromised as a result of activated device functions and/or UI display recommendations which are associated with an incorrect display type. In the flow chart of FIG. 6, the display type is used to determine whether a presentation of a specified UI on the display satisfies power consumption specifications. For example, if (display controller 120 detects that) a user targets a number of very bright images for visual presentation on an OLED display (i.e., a display having a second display type) which exhibits low power consumption efficiency while displaying bright images, the mobile communication device can transmit a notification indicating to the user that the presentation of the selected images will consume a significant amount of battery power. In addition the mobile communication device can provide a prompt that allows the user to determine whether to proceed with viewing the selected images or to select/view less bright images. Similarly, in the flow chart of FIG. 7, the display type is used to determine whether a presentation of a specified UI on the display satisfies power consumption specifications associated with a low battery power state of the device. For example, presentation of very bright images on a display that is less suited for the display of bright images becomes more critical when a low battery power level is detected. As a result, if the user targets the very bright images for visual presentation on an OLED display while the battery is in a low power state, the mobile communication device can transmit a notification indicating to the user that the presentation of the selected images will consume a significant amount of battery power and that the images cannot be displayed at that moment. Unlike the example of FIG. 6, the mobile communication device may no longer provide a user prompt or user selection capability that allows the user to determine whether to proceed with viewing the selected images or to select/view less bright images, since battery power has decreased to a critically low level.

FIG. 6 illustrates one embodiment of a method for evaluating a UI to determine whether a display can satisfy a specified power consumption if the UI is presented on the display. The method of FIG. 6 begins at initiator block 601 and proceeds to block 602 at which display controller 120 detects initiation by a user of a change in UI being presented on the display. Display controller 120 determines whether the display ID information identifying a corresponding display type is available (decision block 604). If display controller 120 determines that the display ID information is available, display controller 120 retrieves from storage the display ID information that identifies a display type of the display (block 606). If display controller 120 determines that the display ID information is not available, display controller 120 determines a type of the display by evaluating the power consumption behavior of the display or retrieving the previously determined display type from memory or storage (block 608). Display controller 120 identifies the display parameter which is associated with a display type of a target display and which is used to identify specific correlated image characteristics of identified UIs (block 610). Display controller 120 evaluates the display parameter value for a specified UI, based on UI image characteristics (block 612). Display controller 120 determines whether the display parameter value is less than a threshold display parameter value which indicates whether a presentation of the specified UI can satisfy a power consumption specification for the display (decision block 614). If the display parameter value is less than the threshold display parameter value, display controller 120 provides a notification that the specified UI does not satisfy a power consumption specification associated with the threshold display parameter value (block 616). If the display parameter value is not less than the threshold display parameter value, display controller 120 provides a notification that the specified UI satisfies a power consumption specification associated with the threshold display parameter value (block 618). The process ends at block 620.

FIG. 7 illustrates one embodiment of a method for evaluating a UI to determine whether a display can satisfy a specified power consumption for low battery power if the UI is presented on the display during a low battery power state of the mobile communication device. The method of FIG. 7 begins at initiator block 701 and proceeds to block 702 at which display controller 120 detects that battery power has decreased to a power threshold value. In one or more embodiments, display controller 120 monitors a remaining battery power of a battery that is powering the display and determines whether the remaining battery power is less than a pre-established remaining power threshold value. In one embodiment, when display controller 120 detects that the remaining battery power is less than the remaining power threshold value, display controller 120 activates a power conservation mechanism by which display controller 120 informs a user of (high) power consumption demands associated with displaying particular types of images and enables a user to selectively determine whether to proceed with displaying the particular images based on the display type of a target display. In response to the remaining battery power being less than the remaining power threshold value, display controller 120 identifies a display type of the display (block 704). Display controller 120 evaluates a display parameter value for a specified UI based on an image characteristics parameter associated with the identified display type (block 706). Display controller 120 determines whether the display parameter value is less than a second threshold parameter value corresponding to a detected low battery power state (decision block 708). Display controller 120 uses the second threshold parameter value to determine whether a presentation of the specified UI can satisfy a low battery power consumption specification for the display. If the display parameter value is less than the second threshold parameter value (and the first threshold parameter value1, display controller 120 provides a notification that the specified UI satisfies a low battery power specification associated with the second threshold parameter value, and display controller 120 presents the specified UI on the display (block 710). In particular, display controller 120 performs one of: presentation of the specified UI on the display when the specified UI is targeted for presentation on the display; and continued presentation of the specified UI on the display when the specified UI is already presented on the display. If the display parameter value is not less than the second threshold parameter value, display controller 120 provides a notification that the specified UI does not satisfy the low battery power specification associated with second threshold parameter value (block 712). Also, in the illustrative embodiment, display controller 120 identifies alternative options comprising alternative or replacement UIs that are acceptable for presentation on the display when the battery is in a low power state and better satisfies power consumption specifications for the low battery power state (block 714). This latter process is optionally performed and can be omitted in one or more implementations. The process ends at block 716.

The flowcharts and block diagrams in the various figures presented and described herein illustrate the architecture, functionality, and operation of possible implementations of systems, methods and computer program products according to various embodiments of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Thus, while the method processes are described and illustrated in a particular sequence, use of a specific sequence of processes is not meant to imply any limitations on the disclosure. Changes may be made with regards to the sequence of processes without departing from the spirit or scope of the present disclosure. Use of a particular sequence is therefore, not to be taken in a limiting sense, and the scope of the present disclosure extends to the appended claims and equivalents thereof.

In some implementations, certain processes of the methods are combined, performed simultaneously or in a different order, or perhaps omitted, without deviating from the spirit and scope of the disclosure. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A method for evaluating user interfaces (UIs) for presentation on a display of a mobile communication device, the method comprising:
determining a type of the display by evaluating a power consumption behavior of the display while presenting a plurality of pre-defined UIs each having distinguishable image characteristics that cause different display types to be associated with distinguishable power consumption behaviors;
based on the determined display type, identifying a specific display parameter and a first threshold display parameter value associated with power consumption specifications for the display, wherein the specific display parameter identifies relevant image characteristics of UIs that can be presented on the display;
evaluating a display parameter value for a specified UI based on the image characteristics of the specified UI;
comparing the display parameter value of the specified UI with the first threshold display parameter value to determine if the specified UI satisfies a power consumption specification for presentation of a UI on the display; and
providing a notification that indicates, based on a result of the comparison, whether the specified UI satisfies the power consumption specification and is recommended for presentation on the display.

2. The method of claim 1, wherein comparing the display parameter value further comprises:
comparing the display parameter value of the specified UI with a first threshold display parameter value corresponding to a recommended power consumption from power consumption specifications of the display;
in response to the display parameter value being at least equal to the first threshold display parameter value, providing an approval for presentation of the specified UI on the display; and
in response to the display parameter value being less than the first threshold display parameter value, providing a notification that the specified UI is not recommended for presentation on the display.

3. The method of claim 1, wherein said determining a type of the display further comprises:
independently presenting within the display each of the plurality of pre-defined UIs comprising at least a first UI having a first distinguishable image characteristic and at least a second UI having a second distinguishable image characteristic;
determining real-time power consumption resulting from a presentation of the pre-defined UIs within the display;
calculating a ratio of a first real-time power consumption associated with the at least one first UI and a second real-time power consumption associated with the at least one second UI; and
determining the display type of the display using the calculated ratio.

4. The method of claim 3, wherein said determining a type of the display further comprises:
comparing the calculated ratio of the first real-time power consumption and the second real-time power consumption with a threshold consumption ratio;
in response to the calculated ratio being at least equal to the threshold consumption ratio, identifying the display type of the display as a first display type; and
in response to the calculated ratio being less than the threshold consumption ratio, identifying the display type of the display as a second display type.

5. The method of claim 3, wherein:
said determining real-time power consumption to identify the display type of the display includes initiating the identification during device initialization; and
the method further comprises:
storing the determined display type of the display; and
retrieving from storage the determined display type to identify the display parameter and power consumption specifications of the display.

6. The method of claim 1, further comprising:
monitoring a remaining battery power of a battery that is powering the display;
determining whether the remaining battery power is less than a pre-established remaining power threshold value;
in response to the remaining battery power being less than the remaining power threshold value and the display parameter value of the specified UI being greater than the first threshold display parameter value, determining whether the display parameter value is less than a second threshold display parameter value associated with a low battery power state of the device;
in response to the display parameter value not being less than the second threshold display parameter value: presenting, in place of the specified UI, a replacement UI that better satisfies power consumption specifications for the low battery power state; and
in response to the display parameter value being less than the second threshold display parameter value, performing one of: presentation of the specified UI on the display when said specified UI is targeted for presentation on the display; and continued presentation of the specified UI on the display when said specified UI is already presented on the display.

7. The method of claim 1, further comprising:
accessing, using the display type, power consumption specifications of the display which provide at least one of: (a) a maximum power consumption that the display can support when a UI is presented within the display; (b) a recommended power consumption for the display when a UI is presented within the display; and (c) an acceptable, low power consumption corresponding to a low battery status.

8. The method of claim 1, wherein said evaluating the display parameter value further comprises:
determining for the specified UI a distribution of pixels comprising at least one of bright pixels and dim pixels;
in response to identifying the display as a first type: calculating a bright pixel count using the determined distribution of pixels; determining a value for a bright pixel ratio from a ratio of the bright pixel count and a total pixel count, wherein said bright pixel ratio is identified as a specific image characteristic parameter for the specified UI; comparing the value for the bright pixel ratio to a threshold bright pixel ratio; in response to the value for the bright pixel ratio being greater than the value of the threshold bright pixel ratio, indicating that the specified UI is recommended for presentation within the display; and in response to the value for the bright pixel ratio not being greater than the value of the threshold bright pixel ratio, indicating that the specified UI is not recommended for presentation within the display; and
in response to identifying the display as a second type: calculating a dim pixel count using the determined distribution of pixels; and determining a value for a dim pixel ratio from a ratio of the dim pixel count and the total pixel count, wherein said dim pixel ratio is identified as a specific image characteristic parameter for the specified UI; comparing the value for the dim pixel ratio to a threshold dim pixel ratio value; in response to the value for the dim pixel ratio being greater than a threshold dim pixel ratio value, indicating that the specified UI is recommended for presentation within the display; and in response to the value for the dim pixel ratio not being greater than the value of the threshold dim pixel ratio, indicating that the specified UI is not recommended for presentation within the display.

9. A mobile communication device which includes:
at least one processor;
a memory system comprising display drivers;
a display for presenting a user interface (UI);
a display controller that:
determines a type of the display by evaluating a power consumption behavior of the display while presenting a plurality of pre-defined UIs each having distinguishable image characteristics that cause different display types to be associated with distinguishable power consumption behaviors;
based on the determined display type, identifies a specific display parameter and a first threshold display parameter value associated with power consumption specifications for the display, wherein the specific display parameter identifies relevant image characteristics of UIs that can be presented on the display;
evaluates a display parameter value for a specified UI based on the image characteristics of the specified UI;
compares the display parameter value of the specified UI with the first threshold display parameter value to determine if the specified UI satisfies a power consumption specification for presentation of a UI on the display; and
provides a notification that indicates, based on a result of the comparison, whether the specified UI satisfies the power consumption specification and is recommended for presentation on the display.

10. The mobile communication device of claim 9, wherein the display controller:
compares the display parameter value of the specified UI with a first threshold display parameter value corresponding to a recommended power consumption from power consumption specifications of the display;
in response to the display parameter value being at least equal to the first threshold display parameter value, provides an approval for presentation of the specified UI on the display; and
in response to the display parameter value being less than the first threshold display parameter value, provides a notification that the specified UI is not recommended for presentation on the display.

11. The mobile communication device of claim 9, wherein the display controller:
independently presents within the display each of the plurality of pre-defined UIs comprising at least a first UI having a first distinguishable image characteristic and at least a second UI having a second distinguishable image characteristic;
determines real-time power consumption resulting from a presentation of the pre-defined UIs within the display;
calculates a ratio of a first real-time power consumption associated with the at least one first UI and a second real-time power consumption associated with the at least one second UI; and
determines the display type of the display using the calculated ratio.

12. The mobile communication device of claim 11, wherein the display controller:
compares the calculated ratio of the first real-time power consumption and the second real-time power consumption with a threshold consumption ratio;
in response to the calculated ratio being at least equal to the threshold consumption ratio, identifies the display type of the display as a first display type; and
in response to the calculated ratio being less than the threshold consumption ratio, identifies the display type of the display as a second display type.

13. The mobile communication device of claim 11, wherein the display controller:
performs measurements of real-time power consumption in order to identify the display type of the display at device initialization;
stores the determined display type of the display; and
retrieves from storage the determined display type to identify the display parameter and power consumption specifications of the display.

14. The mobile communication device of claim 9, wherein the display controller:
monitors a remaining battery power of a battery that is powering the display;
determines whether the remaining battery power is less than a pre-established remaining power threshold value;
in response to the remaining battery power being less than the remaining power threshold value and the display parameter value of the specified UI being greater than the first threshold display parameter value, determines whether the display parameter value is less than a second threshold display parameter value associated with a low battery power state of the device;
in response to the display parameter value not being less than the second threshold display parameter value: presents, in place of the specified UI, a replacement UI that better satisfies power consumption specifications for the low battery power state; and
in response to the display parameter value being less than the second threshold display parameter value, performs one of: presentation of the specified UI on the display when said specified UI is targeted for presentation on the display; and continued presentation of the specified UI on the display when said specified UI is already presented on the display.

15. The mobile communication device of claim 9, wherein the display controller:
accessing, using the display type, power consumption specifications of the display which provide at least one of: (a) a maximum power consumption that the display can support when a UI is presented within the display; (b) a recommended power consumption for the display when a UI is presented within the display; and (c) an acceptable, low power consumption corresponding to a low battery status.

16. The mobile communication device of claim 9, wherein the display controller:
determines for the specified UI a distribution of pixels comprising at least one of bright pixels and dim pixels;
in response to identifying the display as a first type: calculates a bright pixel count using the determined distribution of pixels; determining a value for a bright pixel ratio from a ratio of the bright pixel count and a total pixel count, wherein said bright pixel ratio is identified as a specific image characteristic parameter for the specified UI; compares the value for the bright pixel ratio to a threshold bright pixel ratio; in response to the value for the bright pixel ratio being greater than the value of the threshold bright pixel ratio, indicates that the specified UI is recommended for presentation within the display; and in response to the value for the bright pixel ratio not being greater than the value of the threshold bright pixel ratio, indicates that the specified UI is not recommended for presentation within the display; and
in response to identifying the display as a second type: calculates a dim pixel count using the determined distribution of pixels; and determines a value for a dim pixel ratio from a ratio of the dim pixel count and the total pixel count, wherein said dim pixel ratio is identified as a specific image characteristic parameter for the specified UI; compares the value for the dim pixel ratio to a threshold dim pixel ratio value; in response to the value for the dim pixel ratio being greater than a threshold dim pixel ratio value, indicates that the specified UI is recommended for presentation within the display; and in response to the value for the dim pixel ratio not being greater than the value of the threshold dim pixel ratio, indicates that the specified UI is not recommended for presentation within the display.
